(19) United States
(12) Patent Application Publication
(10) Pub. No.: US 2012/0062181 A1
(43) Pub. Date: Mar. 15, 2012

(54) APPARATUS AND METHOD FOR CHARGING OF BATTERY IN PORTABLE TERMINAL

(75) Inventors: Jung-Woo Lee, Seoul (KR); Do-Yeon Kim, Suwon-si (KR)

(73) Assignee: SAMSUNG ELECTRONICS CO., LTD., Suwon-si (KR)

(21) Appl. No.: 13/218,791

(22) Filed: Aug. 26, 2011

(30) Foreign Application Priority Data
Sep. 15, 2010 (KR) 10-2010-0090321

(51) Int. Cl. H02J 7/00

(52) U.S. Cl. 320/138; 320/162

(57) ABSTRACT

An apparatus and method for charging of a battery in a portable terminal. The apparatus includes a charge management unit and a controller. The charge management unit determines a predefined charge threshold value and a battery voltage, compares the battery voltage with the threshold value, and determines if the battery voltage is suitable for normal operation of the portable terminal. If it is determined by the charge management unit that the battery voltage is not suitable for normal operation, the controller sends a power supply request to an external device.

### CROSS-REFERENCE TO RELATED APPLICATION(S) AND CLAIM OF PRIORITY

The present application is related to and claims the benefit under 35 U.S.C. §119(a) to a Korean patent application filed in the Korean Intellectual Property Office on Sep. 15, 2010 and assigned Serial No. 10-2010-0090321, the contents of which are herein incorporated by reference.

### TECHNICAL FIELD OF THE INVENTION

The present invention relates to an apparatus and method for charging of a battery in a portable terminal. More particularly, the present invention relates to an apparatus and method for selectively performing a battery charge process according to a current voltage of a battery in a portable terminal, connecting with an external device, and performing the battery charge process.

### BACKGROUND OF THE INVENTION

Use of portable terminals is spreading quickly due to the portability of the terminals. Thus, service providers (i.e., system manufacturers) are competitively developing portable terminals having more convenient functions to attract many users.

For example, many portable terminals provide the functions of a phone book, a game, a scheduler, a Short Message Service (SMS), a Multimedia Message Service (MMS), a Broadcast Message Service (BMS), an Internet service, an electronic mail (e-mail) service, a morning call, a Motion Picture Expert Group (MPEG)-1 Audio Layer 3 (MP3), digital cameras and the like.

To provide the advantage of mobility, the portable terminals use rechargeable batteries as a power supply means. Because the rechargeable battery has a restricted capacity, when a use time of the portable terminal grows longer, an available battery consumption time is shortened. So, there occurs a problem that a user must check the charge state of the rechargeable battery regularly when long-time traveling or going out and may need to supply external power to charge the rechargeable battery.

Recently, a multimedia communication network has been built to gather diverse information through an Internet network. Technologies for accessing the Internet network using the portable terminal are under development. Various complex portable terminals (e.g., smart phones) having various supplementary functions have been developed but their battery consumption is getting worse and worse.

A typical complex portable terminal makes use of many programs interworking with a Personal Computer (PC) and receives a supply of power from the PC to charge a battery of the portable terminal. For this reason, a user may wish to keep the portable terminal connecting to the PC during the time of using the PC.

Unlike the PC receiving a supply of power from an external source, a notebook PC uses a rechargeable battery and, if the portable terminal is connected, the notebook PC automatically provides power of its rechargeable battery to the portable terminal.

However, if the portable terminal is connected to the notebook PC with a battery level sufficient, it leads to a waste of power of the notebook PC through an unnecessary power supply process, thereby causing a problem that PC work desired by a user is made difficult or impossible.

To solve the problem, there is a need for an apparatus and method for a portable terminal to selectively receive a supply of power from an external device (e.g., a notebook PC).

### SUMMARY OF THE INVENTION

An aspect of the present invention is to substantially solve at least the above problems and/or disadvantages and to provide at least the advantages below. Accordingly, one aspect of the present invention is to provide an apparatus and method for selectively performing a battery charge process carried out by a supply of power from an external device in a portable terminal.

Another aspect of the present invention is to provide an apparatus and method for reducing the consumption of power of an external device through a selective battery charge process in a portable terminal.

Yet another aspect of the present invention is to provide an apparatus and method for, if determining a battery voltage is less than a preset threshold value, sending a power supply request to an external device in a portable terminal.

In accordance with an aspect of the present invention, an apparatus for charging of a battery in a portable terminal is provided. The apparatus includes a charge management unit and a controller. The charge management unit determines a predefined charge threshold value and a battery voltage, compares the battery voltage with the threshold value, and determines if the battery voltage is suitable for normal operation of the portable terminal. If it is determined by the charge management unit that the battery voltage is not suitable for normal operation, the controller sends a power supply request to an external device.

In accordance with another aspect of the present invention, a method for charging of a battery in a portable terminal is provided. The method includes determining a predefined charge threshold value and a battery voltage, comparing the battery voltage with the threshold value and determining if the battery voltage is suitable for normal operation of the portable terminal. The method also includes, if the battery voltage is not suitable for normal operation, sending a power supply request to an external device.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a construction of a portable terminal for setting a time of a supply of power from an external device according to the present invention;

FIG. 2A illustrates a hardware construction of a charge management unit according to a desirable embodiment of the present invention;

FIG. 2B illustrates a functional construction of a charge management unit according to an embodiment of the present invention;

FIG. 3 illustrates a process of setting a charge threshold value for determining a time of a supply of power of an external device in a portable terminal according to an embodiment of the present invention;

FIG. 4 illustrates a process of charging a battery using power of an external device in a portable terminal according to an embodiment of the present invention;

FIGS. 5A and 5B illustrate a process of determining a time of a supply of power of an external device in a portable terminal according to an embodiment of the present invention; and

FIGS. 5C and 5D illustrate a process of controlling a supply of power of an external device in a portable terminal according to an embodiment of the present invention.

Throughout the drawings, like reference numerals will be understood to refer to like parts, components and structures.

### DETAILED DESCRIPTION OF THE INVENTION

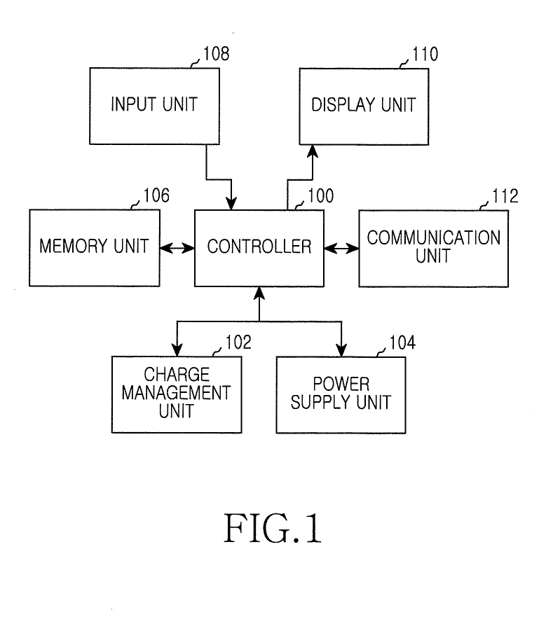

FIGS. 1 through 5D, discussed below, and the various embodiments used to describe the principles of the present disclosure in this patent document are by way of illustration only and should not be construed in any way to limit the scope of the disclosure.

Embodiments of the present invention provide an apparatus and method for reducing the consumption of power of an external device through a selective battery charge process in a portable terminal.

FIG. 1 illustrates a construction of a portable terminal for setting a time of a supply of power from an external device according to the present invention.

As shown in FIG. 1, the portable terminal can include a controller 100, a charge management unit 102, a power supply unit 104, a memory unit 106, an input unit 108, a display unit 110, and a communication unit 112.

The controller 100 of the portable terminal controls the general operation of the portable terminal. For example, the controller 100 performs processing and control for voice calls and data communication and, in addition to general functions, according to the present invention, the controller 100 sets a charge threshold value used for determining a time of a supply of power from an external device, compares a battery voltage with the charge threshold value, and determines the time of a supply of power of the external device.

After that, the controller 100 processes to send a power supply request to the external device only at the time of a supply of power from the external device, thereby reducing the consumption of power of the external device.

The charge management unit 102 determines a time of a supply of power from the external device under the control of the controller 100.

The charge management unit 102 periodically measures a voltage of the power supply unit 104, compares the voltage of the power supply unit 104 with the charge threshold value, and determines the power supply time. For example, if the measured voltage is less than the charge threshold value, the charge management unit 102 can determine that a supply of power of an external device is necessary. In contrast, if the measured voltage is greater than the charge threshold value, the charge management unit 102 can determine that the supply of power of the external device is unnecessary.

The power supply unit 104, which is for supplying power for operation of the portable terminal, represents a battery of the portable terminal. According to an embodiment of the present invention, if a voltage of the power supply unit 104 is less than the charge threshold value, the power supply unit 104 can be charged using power of the external device.

The memory unit 106 preferably includes, for example, a Read Only Memory (ROM), a Random Access Memory (RAM), a flash ROM, and such. The ROM stores a microcode of a program for processing and controlling the controller 100 and the charge management unit 102 and a variety of reference data.

The RAM, a working memory of the controller 100, stores temporary data generated in execution of a variety of programs. The flash ROM stores a diversity of updateable depository data such as a phone book, an outgoing message, an incoming message, and the like.

The input unit 108 includes numeral key buttons ‘0’ to ‘9’, a menu button, a cancel button, an OK button, a talk button, an end button, an Internet button, navigation key (or direction key) buttons, and a plurality of function keys such as a character input key. The input unit 108 provides key input data corresponding to a key pressed by a user to the controller 100.

The display unit 110 displays state information generated during operation of the portable terminal, characters, moving pictures, still pictures, and the like. The display unit 110 may be a color Liquid Crystal Display (LCD), Active Mode Organic Light Emitting Diode (AMOLED), and such. In embodiments where the display unit 110 includes a touch input device, the display unit 110 can be used as an input device of the portable terminal.

The communication unit 112 performs functions for transmitting, receiving and processing wireless signals of data input/output through an antenna (not illustrated). For example, in a transmission mode, the communication unit 112 performs functions for processing original data through channel coding and spreading, converting the original data into a Radio Frequency (RF) signal, and transmitting the RF signal. In a reception mode, the communication unit 112 performs functions for converting a received RF signal into a baseband signal, processing the baseband signal through de-spreading and channel decoding, and restoring the signal to original data.

A function of the charge management unit 102 can be implemented by the controller 100 of the portable terminal. Although FIG. 1 shows the change management unit 102 and the controller 100 as separate units, this is an exemplary construction for description convenience, and should not limit the scope of the present invention. It should be understood by those skilled in the art that various modifications of construction can be made within the scope of the present invention. For example, construction may be such that some or all of the functions listed above are processed in the controller 100.

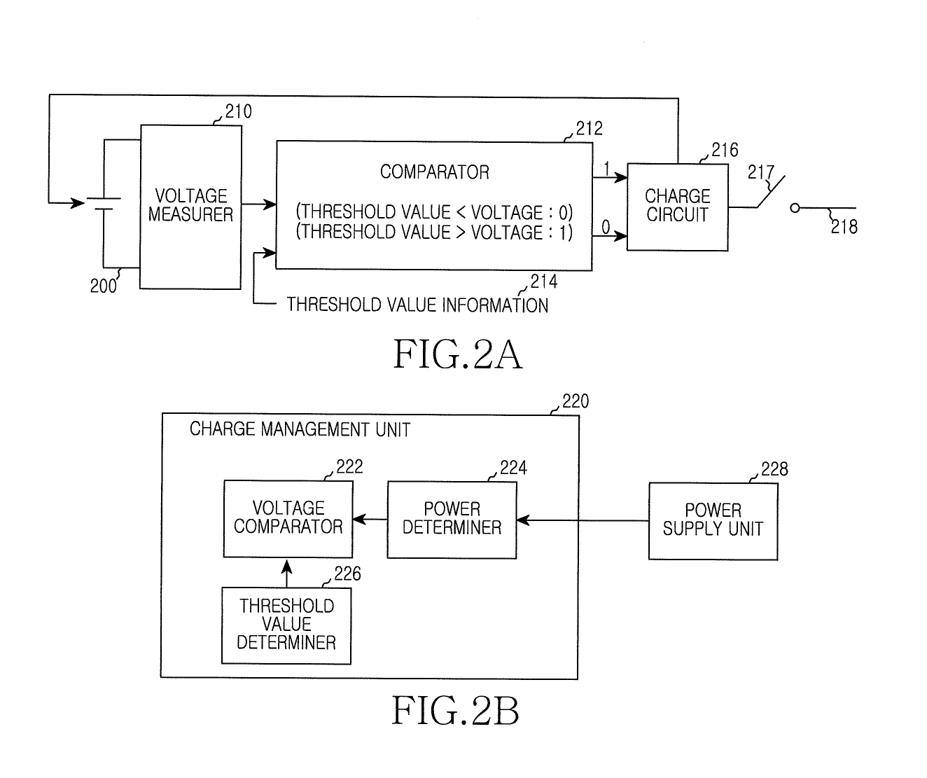

FIGS. 2A and 2B illustrate a construction of a charge management unit according to an embodiment of the present invention.

FIG. 2A illustrates a hardware construction of a charge management unit according to an embodiment of the present invention.

Referring to FIG. 2A, the charge management unit can include a voltage measurer 210 for measuring a voltage of a battery 200, a comparator 212 for comparing the battery voltage measured by the voltage measurer 210 with a threshold value set by a user, and a charge circuit 216 for performing a charging process according to the comparison result of the comparator 212.

First, the voltage measurer 210 measures a charging voltage of the battery 200 of a portable terminal, and delivers the measured charging voltage to the comparator 212.

The comparator 212 is for determining a time of a supply of power of an external device. In other words, the comparator 212 can determine a time that a supply of power for a portable terminal will be supplied from an external device. The comparator 212 compares the charging voltage of the battery 200 provided from the voltage measurer 210 with information 214 of a charge threshold value set by a user, and determines the power supply time. For one example, if the comparator 212 determines a battery voltage greater than a charge threshold value, the comparator 212 can determine that a supply of power of an external device is unnecessary since the portable terminal currently has a sufficient battery level. Based on the sufficient battery level, the comparator 212 processes to output a signal ‘0’ for stopping a supply of power of the external device to the charge circuit 216 and save the power of the external device.

In contrast, if the comparator 212 determines a battery voltage less than the charge threshold value, the comparator 212 can determine that the supply of power of the external device is necessary since the portable terminal currently has an insufficient battery level. Based on the insufficient battery level, the comparator 212 processes to output a signal ‘1’ for requesting a supply of power of the external device to the charge circuit 216 and receive a supply of power from the external device to charge a battery.

If the charge circuit 216 is provided with a signal controlling a supply of power of an external device as above, the charge circuit 216 performs an operation corresponding to the provided signal. That is, if receiving a signal for supplying power of the external device from the comparator 212, the charge circuit 216 connects a path for providing the external device with the signal, using a switch 217. After that, through the path connected using the switch 217, the charge circuit 216 receives a supply of power 218 provided from the external device. In addition, the charge circuit 216 may charge the battery 200 using the supplied power 218.

FIG. 2B illustrates a functional construction of a charge management unit according to an embodiment of the present invention.

Referring to FIG. 2B, the charge management unit 220 can include a voltage comparator 222, a power determiner 224, and a threshold value determiner 226.

The voltage comparator 222 compares remnant power (i.e., a battery level) of a power supply unit 228 with a charge threshold value set by a user. The power determiner 224 connects with the power supply unit 228 and measures the remnant power of the power supply unit 228.

The threshold value determiner 226 sets a charge threshold value used for determining a time of a supply of power of an external device charging the power supply unit 228, and provides the set charge threshold value to the voltage comparator 222.

That is, a portable terminal according to the present invention can perform a battery charge process using power of an external device by way of the hardware construction of FIG. 2A and, using software such as a computer program, can process to perform the battery charge process using the power of the external device.

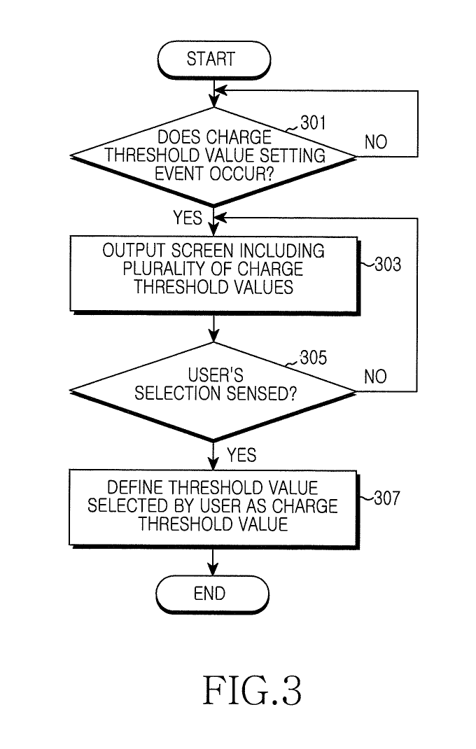

FIG. 3 illustrates a process of setting a charge threshold value for determining a time of a supply of power from an external device to a portable terminal according to an embodiment of the present invention.

Referring to FIG. 3, in step 301, the portable terminal determines if a charge threshold value setting event occurs. Here, the charge threshold value refers to a threshold value used for determining a time of a supply of power from an external device to charge a battery of the portable terminal, and step 301 is for determining if an event for a user to set the reference value occurs.

If it is determined in step 301 that the charge threshold value setting event does not occur, the portable terminal again performs the process of step 301.

Alternatively, if it is determined in step 301 that the charge threshold value setting event occurs, the portable terminal proceeds to step 303 and outputs a screen including a plurality of charge threshold values. The screen including the plurality of charge threshold values refers to a screen including maximum battery capacity values of the portable terminal.

After that, the portable terminal proceeds to step 305 and determines if a charge threshold value is selected by a user.

If it is determined in step 305 that the charge threshold value is not selected by the user, the portable terminal again performs the process of step 303.

Alternatively, if it is determined in step 305 that the charge threshold value is selected by the user, the portable terminal proceeds to step 307 and defines the threshold value selected by the user as a charge threshold value. After that, the portable terminal terminates the algorithm.

In FIG. 3, a user selects a charge threshold value using a plurality of charging voltage figures. In another embodiment, the present invention defines a charge threshold value dependent on the number of indicators of a battery bar as shown in Table 1 below, so the portable terminal can determine a state of the battery bar to determine a battery voltage.

TABLE 1

| User's setting | Set voltage |
|---|---|
| One indicator of battery bar | 3.5 V |
| Two indicators of battery bar | 3.7 V |
| Three indicators of battery bar | 3.9 V |
| Four indicators of battery bar | 4.1 V |

When using a battery bar as above, a user can determine a current output state of the battery bar and determine a time of a supply of power from an external device, and the portable terminal also can simply and conveniently determine charge threshold value setting and power supply time using battery bar information in Table 1.

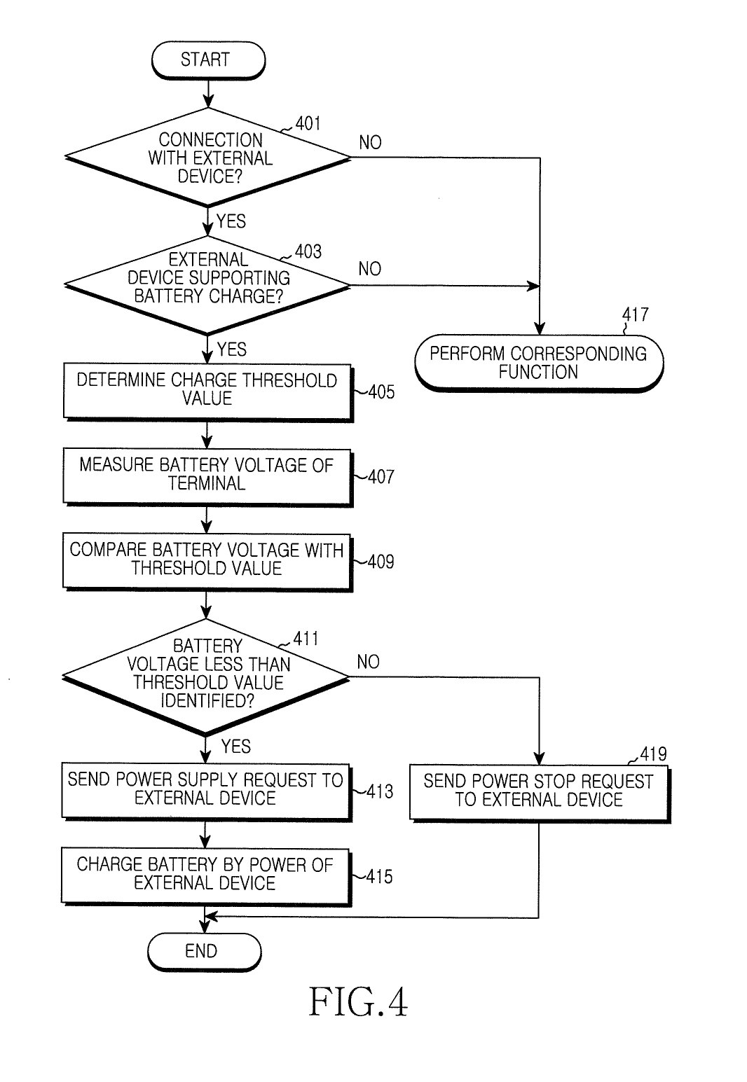

FIG. 4 illustrates a process of charging a battery using power of an external device in a portable terminal according to an embodiment of the present invention.

Referring to FIG. 4, in step 401, the portable terminal determines if a connection with an external device is made. Here, the connection with the external device refers to connecting with the external device such as a notebook computer using a data cable or other connecting means.

If it is determined in step 401 that the connection with the external device is not made, the portable terminal proceeds to step 417 and performs a corresponding function (e.g., an idle mode).

Alternatively, if it is determined in step 401 that the connection with the external device is made, the portable terminal proceeds to step 403 and determines if it has made connection with an external device capable of supporting a battery charge.

If it is determined in step 403 that the portable terminal has made connection with an external device that is not capable of supporting a battery charge, the portable terminal proceeds to step 417 and performs a corresponding function (e.g., data communication).

Alternatively, if it is determined in step 403 that the portable terminal has made the connection with an external device that is capable of supporting the battery charge, the portable terminal proceeds to step 405 and determines a charge threshold value associated with the portable terminal. After that, the portable terminal proceeds to step 407 and measures a battery voltage of the portable terminal.

Next, the portable terminal proceeds to step 409 and compares the battery voltage with the charge threshold value to determine a time of a supply of power from the external device. Next, the portable terminal proceeds to step 411 and determines the determination result of step 409.

If it is determined in step 411 that the time of a supply of power from an external device is the current time, that is, if it is determined that the portable terminal cannot perform normal operation because the battery voltage is less than the charge threshold value, the portable terminal proceeds to step 413 and sends a power supply request to the external device.

Next, the portable terminal proceeds to step 415 and charges a battery of the portable terminal using the power provided from the external device.

Alternatively, if it is determined in step 411 that the time of a supply of power from the external device is not the current time, that is, if it is determined that the portable terminal can perform normal operation because the battery voltage is greater than the charge threshold value, the portable terminal proceeds to step 419 and sends a power supply stop request to the external device.

After determining a time of a supply of power from the external device and controlling a battery charge process as above, the portable terminal terminates the algorithm.

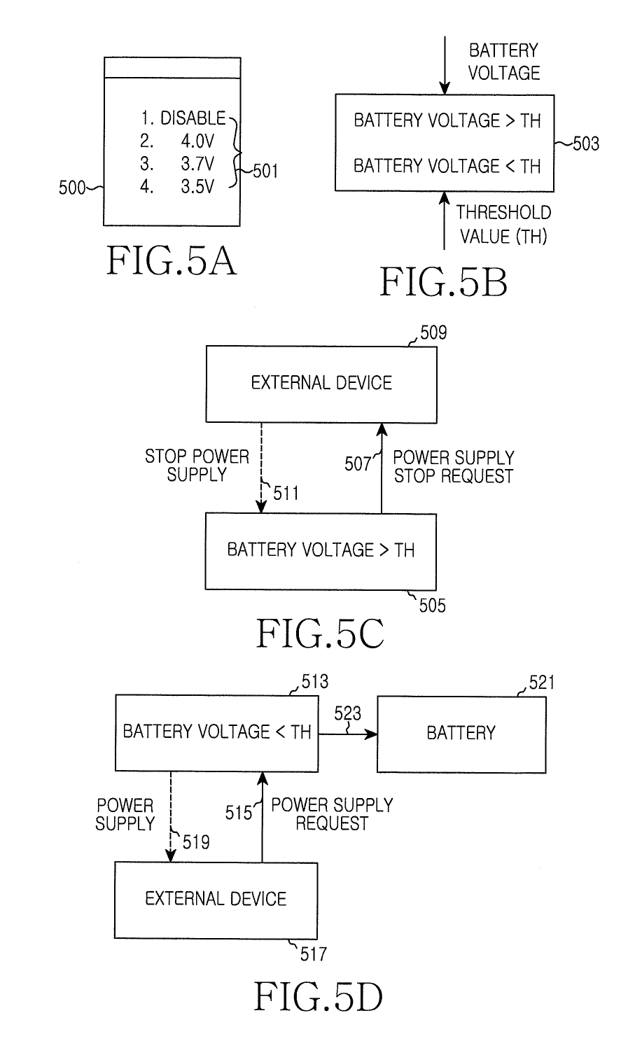

FIGS. 5A through 5D illustrate a process of charging a battery using power of an external device in a portable terminal according to an embodiment of the present invention.

FIGS. 5A and 5B illustrate a process of determining a time of a supply of power from an external device in a portable terminal according to an embodiment of the present invention.

Referring to FIGS. 5A and 5B, if the portable terminal senses an input for charge threshold value setting from a user, the portable terminal outputs (500) a screen including a plurality of threshold values 501 as illustrated.

The user can select any one of the output threshold values 501 and set the selected threshold value as a charge threshold value (TH).

After that, the portable terminal compares (503) a battery voltage of the portable terminal with the set charge threshold value (TH) and determines a time of a supply of power from an external device.

That is, if the portable terminal determines a battery voltage less than a threshold value (TH), the portable terminal can determine that the battery voltage cannot control a normal operation of the portable terminal because the battery voltage is less than the threshold value (TH).

In contrast, if the portable terminal determines a battery voltage greater than the threshold value (TH), the portable terminal can determine that the battery voltage can control the normal operation of the portable terminal because the battery voltage is greater than the threshold value (TH).

FIGS. 5C and 5D illustrate a process of controlling a supply of power from an external device in a portable terminal according to an embodiment of the present invention.

Referring to FIGS. 5C and 5D, the portable terminal may determine a battery voltage capable of controlling a normal operation of the portable terminal through the process of FIGS. 5A and 5B.

If the portable terminal determines (505) that a battery voltage is greater than a charge threshold value (TH) through the above determination, the portable terminal may determine that an unnecessary charge process can lead to a waste of power of an external device 509, and send a power supply stop request (507) to the external device 509.

In this situation, the external device 509 may stop power supply (511) to the portable terminal.

Further, if the portable terminal determines (513) that a battery voltage is less than a threshold value (TH) through the process of FIG. 5A, the portable terminal may determine that a battery charge process is necessary, and perform a power supply request 515 to an external device 517.

In this situation, the external device 517 may perform power supply (519) to the portable terminal, and the portable terminal may charge (523) a battery 521 using power of the external device 517.

As described above, the present invention relates to an apparatus and method for reducing the consumption of power of an external device through a selective battery charge process. When a battery voltage is determined to be less than a preset threshold value, the present invention charges a battery of a portable terminal using the power of the external device, thereby saving the power of the external device.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for charging of a battery in a portable terminal, the apparatus comprising:
a charge management unit configured to determine a predefined charge threshold value and a battery voltage, compare the battery voltage with the threshold value, and determine if the battery voltage is suitable for normal operation of the portable terminal; and
a controller configured, if it is determined by the charge management unit that the battery voltage is not suitable for normal operation, to send a power supply request to an external device.

2. The apparatus of claim 1, wherein, after sending the power supply request to the external device, the controller charges a battery by supplied power of the external device.

3. The apparatus of claim 1, wherein, upon a determination that the battery voltage is less than the threshold value, the charge management unit determines that the battery voltage is not suitable for normal operation and, upon a determination that the battery voltage is greater than the threshold value, determines that the battery voltage is suitable for normal operation.

4. The apparatus of claim 1, wherein the charge management unit comprises a comparator configured to compare the battery voltage with the threshold value.

5. The apparatus of claim 1, wherein the charge management unit comprises a program configured to determine a state of a battery bar.

6. The apparatus of claim 1, wherein the charge threshold value is changed according to user's selection.

7. The apparatus of claim 6, wherein the charge threshold value is set by selecting a target charge threshold value from a threshold value list comprising a plurality of threshold values, or by selecting a number of indicators of a battery bar after mapping a threshold value according to a state of the battery bar.

8. A method for charging of a battery in a portable terminal, the method comprising:
determining a predefined charge threshold value and a battery voltage;
comparing the battery voltage with the threshold value, and determining if the battery voltage is suitable for normal operation of the portable terminal; and
if the battery voltage is not suitable for normal operation, sending a power supply request to an external device.

9. The method of claim 8, further comprising, after sending the power supply request to the external device, charging a battery by supplied power of the external device.

10. The method of claim 8, wherein determining if the battery voltage is suitable for normal operation of the portable terminal comprises:
upon a determination that the battery voltage is less than the threshold value, determining that the battery voltage is not suitable for normal operation; and
upon a determination that the battery voltage is greater than the threshold value, determining that the battery voltage is suitable for normal operation.

11. The method of claim 8, wherein determining if the battery voltage is suitable for normal operation of the portable terminal comprises using a comparator for comparing the battery voltage with the threshold value.

12. The method of claim 8, wherein determining if the battery voltage is suitable for normal operation of the portable terminal comprises using a program for determining a state of a battery bar.

13. The method of claim 8, wherein the charge threshold value is changed according to user's selection.

14. The method of claim 13, wherein the charge threshold value is set by selecting a target charge threshold value from a threshold value list comprising a plurality of threshold values, or by selecting a number of indicators of a battery bar after mapping a threshold value according to a state of the battery bar.

15. A portable terminal, comprising:
a battery; and
an apparatus for charging the battery, the apparatus comprising:
a charge management unit configured to determine a predefined charge threshold value and a battery voltage, compare the battery voltage with the threshold value, and determine if the battery voltage is suitable for normal operation of the portable terminal; and
a controller configured, if it is determined by the charge management unit that the battery voltage is not suitable for normal operation, to send a power supply request to an external device.

16. The portable terminal of claim 15, wherein, after sending the power supply request to the external device, the controller charges a battery by supplied power of the external device.

17. The portable terminal of claim 15, wherein, upon a determination that the battery voltage is less than the threshold value, the charge management unit determines that the battery voltage is not suitable for normal operation and, upon a determination that the battery voltage is greater than the threshold value, determines that the battery voltage is suitable for normal operation.

18. The portable terminal of claim 15, wherein the charge management unit comprises a comparator configured to compare the battery voltage with the threshold value.

19. The portable terminal of claim 15, wherein the charge management unit comprises a program configured to determine a state of a battery bar.

20. The portable terminal of claim 15, wherein the charge threshold value is changed according to user's selection.
